(19) United States
(12) Patent Application Publication
(10) Pub. No.: US 2026/0247485 A1
(43) Pub. Date: Aug. 20, 2026

(54) Method for Making an Emergency Call in a Vehicle

(71) Applicant: Daimler Truck AG, Leinfelden-Echterdingen (DE)

(72) Inventors: Ralf OBERFELL, Stuttgart (DE); Wilhemus KOK, Weinstadt (DE)

(21) Appl. No.: 19/165,317

(22) PCT Filed: Feb. 7, 2024
(86) PCT No.: PCT/EP2024/053002

§ 371 Date: Sep. 15, 2025

(30) Foreign Application Priority Data
Mar. 16, 2023 (DE) 10 2023 106 616.1

(51) Int. Cl. H04W 76/50; H04W 4/44; H04W 4/90; H04W 64/00

(52) U.S. Cl. CPC H04W 76/50; H04W 4/44; H04W 4/90; H04W 64/00

(57) ABSTRACT

A method for making an emergency call in a vehicle, where, when dialling an emergency number using a mobile device, an interface having an input screen appears on the mobile device or on a secondary display in the vehicle, prompting the input or correction of the following features: caller identity; emergency location, the coordinates of which are determined using a global satellite navigation system, where a cartographic description of the emergency location is added based on data from a digital map; number of people involved; number of vehicle occupants; and description of the situation where situation images of an area outside the vehicle are created using cameras disposed on the vehicle. The interface is configured such that a connection to the emergency number can only be terminated by at least double confirmation. The situation images are updated at regular intervals of a few seconds and are archived.

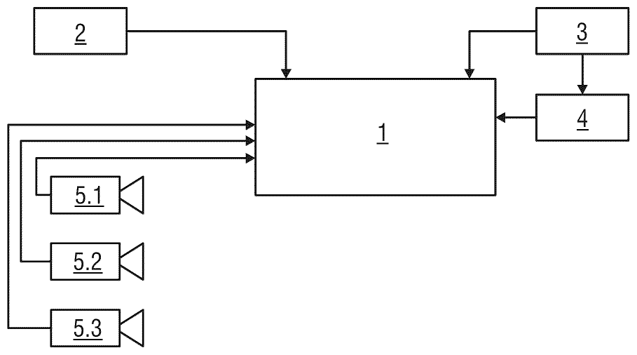

### BACKGROUND AND SUMMARY OF THE INVENTION

The invention relates to a method for making an emergency call in a vehicle.

Making an emergency call is an important part of the rescue chain. The so-called 5 W's Rule is known as follows:
Where is the incident?
Who is calling?
What has happened?
What number of people are involved?
Wait for further questions!

However, it is often difficult for those involved to follow this rule. In particular, callers often find it difficult to locate the scene of the accident or emergency. In addition, in many cases there is no precise description of the emergency situation.

It is also known that smartphones can be located when an emergency call is made. Furthermore, emergency call apps are available for people with speech and hearing impairments.

US 2020/0029194 A1 describes a headlight assembly for use in a vehicle and for reporting emergency conditions to a dispatcher, wherein the headlight assembly comprises a housing forming a cavity, a processor mounted in the cavity, a wireless transceiver carried by the housing and connected to the processor, at least one first sensor device for detecting at least one first condition while the vehicle is in operation, wherein the first sensor device is in communication with the processor, wherein the processor is programmed to receive data from the at least one first sensor device, analyse the received data to assess the probability that an emergency condition exists, and, upon determining that the probability of an emergency condition is greater than a first threshold, automatically initiating wireless emergency notification communication with an emergency control center.

The object of the invention is to specify a novel method for making an emergency call in a vehicle.

A method for making an emergency call in a vehicle is provided, wherein, when dialling an emergency number using a mobile device, an interface appears on the mobile device or on a secondary display in the vehicle, wherein the following features are transmitted:
caller identity,
emergency location, wherein the coordinates of the emergency location are determined using a global satellite navigation system in the vehicle or mobile device and transferred to the user interface,
situation images of an area outside the vehicle, which are created to describe the situation using cameras provided on the vehicle,
   wherein the interface is configured in such a way that the connection to the emergency number cannot be terminated by a single action, but only by at least two confirmations.

It is provided in accordance with the invention that an input mask appears on the interface (1), prompting the input or correction of the following features:
caller identity,
emergency location (e.g., also via “what3words”),
number of people involved,
number of occupants in the vehicle, and
description of the situation,
   wherein the caller identity is taken from a tachograph from a driver card or from a currently selected driver profile or from personal data available on the mobile device, wherein a cartographic description of the emergency location is added based on data from a digital map, wherein the number of occupants in the vehicle is determined by seat recognition and/or seat belt recognition and by an interior camera, wherein the situation images are updated at regular intervals of a few seconds, wherein the situation images are archived.

The solution in accordance with the invention enables an emergency call to be made quickly and accurately, wherein the emergency control center receives a better picture of the situation thanks to photographic images.

The vehicle can be, for example, a commercial vehicle, bus or passenger car.

Exemplary embodiments of the invention are explained in more detail below using the drawing.

### BRIEF DESCRIPTION OF THE DRAWING

The FIGURE is a schematic view of a method for making an emergency call.

### DETAILED DESCRIPTION OF THE DRAWING

The single figure is a schematic view of a method for making an emergency call in a vehicle.

The vehicle is provided with a mobile device, such as a smartphone, and/or a secondary display on which an interface 1 appears when the emergency number (e.g., 112 or 911) of an emergency control center is dialled. This interface 1 has a screen that helps the caller to describe the emergency situation. The screen prompts the caller to input the following information:
caller identity: who is calling? It can be provided that the caller identity information is taken from a tachograph 2, a driver card, a currently selected driver profile or personal data stored on the mobile device (e.g., AppleID or Google user) and already entered on the screen. Alternatively, the caller can enter or edit the name manually.
Accident location or emergency location: where is the emergency location? The coordinates of the vehicle and thus the emergency location are determined, for example, by means of a global navigation satellite system (GNSS) 3 of the vehicle or the mobile device and are also added to the screen. In addition to the coordinates, a cartographic description (e.g., motorway A8, exit xy, heading north, kilometre 53) can be added based on data from a digital map 4. Alternatively, the caller can enter or edit this information manually.
Number of people involved: there is an input field for this feature provided on the screen.
Number of vehicle occupants: the number of people in the vehicle from which the emergency call is made can be determined by seat detection and/or seat belt detection and/or an interior camera. Alternatively, the caller can enter or edit this information manually.
Situation description: situation images are captured and transmitted from outside the vehicle using at least one camera 5.1, 5.2, 5.3 (e.g., multifunction camera-MPC, MCS, SVS) provided on the vehicle. The situation can be updated at regular intervals of a few seconds. The image data can also be archived for later investigation by the police.

The interface 1 can be configured in such a way that it is not possible to terminate the connection to the emergency control center by a single action, but that at least two confirmations are required to terminate the connection.

### List of Reference Characters

1 interface
2 tachograph
3 navigation satellite system
4 map
5.1, 5.2, 5.3 camera

1. (canceled)

2. A method for making an emergency call in a vehicle, comprising:
dialling an emergency number using a mobile device, wherein when dialling, an interface (1) appears on the mobile device or on a secondary display in the vehicle;
wherein the interface (1) is configured such that a connection to the emergency number cannot be terminated by a single action but only by at least two confirmations;
wherein an input mask appears on the interface (1) prompting an input or correction of:
a caller identity, wherein the caller identity is taken from a tachograph (2) from a driver card or from a currently selected driver profile or from personal data available on the mobile device;
an emergency location, wherein a cartographic description of the emergency location is added based on data from a digital map (4);
a number of people involved;
a number of occupants in the vehicle, wherein the number of occupants is determined by seat recognition or seat belt recognition and by an interior camera of the vehicle; and
a description of the situation, wherein situation images are updated at regular intervals and are archived.
